(19) United States
(12) Patent Application Publication
(10) Pub. No.: US 2013/0191767 A1
(43) Pub. Date: Jul. 25, 2013

(54) Semantic Zooming of Data Object Representations in a User Interface

(71) Applicants: Johan Christiaan Peters, Sankt Leon-Rot (DE); Udo Arend, Heidelberg (DE); Vera Legisa, Karlsruhe (DE)

(72) Inventors: Johan Christiaan Peters, Sankt Leon-Rot (DE); Udo Arend, Heidelberg (DE); Vera Legisa, Karlsruhe (DE)

(73) Assignee: SAP AG, Walldorf (DE)

(21) Appl. No.: 13/357,818

(22) Filed: Jan. 25, 2012

(51) Int. Cl. G06F 3/048

(52) U.S. Cl. 715/765

(57) ABSTRACT

Example systems and methods of semantic zooming of data object representations in a user interface are presented. In one implementation, a first graphical representation is presented for display. The first graphical representation represents a data object and presents first information associated with the data object. A user input indicating a zoom-in operation is received. In response to the user input, the first graphical representation is replaced with a second graphical representation representing the first data object is presented for display. The second graphical representation presents second information that includes more information than the first information.

### FIELD

The present disclosure relates generally to user interfaces and, more specifically, to semantic zooming involving data objects represented in a user interface.

### BACKGROUND

In many user interfaces, such as the desktop interface provided by the Microsoft® Windows® operating system, an array of icons is presented to a user, with each of the icons representing a file or a folder possibly containing other files. For each file, a corresponding icon typically displays a graphical representation of the file based on an extension of the file name, which often indicates the type of file involved, as well as the application that uses the file. The icon may also be accompanied with a file name to distinguish the icon from other similar icons displayed on the desktop. Ordinarily, a user selects one of the files, such as by way of positioning a cursor over the file of interest via a mouse and double-clicking a selection button of the mouse in order to open the file and either view the contents or otherwise interact with the file using the application associated with the file. For folders, a user may open a folder in a similar fashion to view the icons of the individual files and/or other folders contained therein.

Ordinarily, such a system is compatible with desktop and laptop computer systems, which typically provide a sizeable display unit for viewing multiple icons on the desktop simultaneously. However, smaller devices, such as cellular phones and personal digital assistants (PDAs), which provide correspondingly smaller displays, typically may only present a few desktop-style icons and associated file names at any one time. Instead, such devices typically provide smaller icons representing only applications.

To enhance readability of some types of data on a display, some systems provide a zooming or zoomable user interface (ZUI), a type of graphical user interface (GUI) in which a user may alter the scale of a display to view details of the display that may otherwise be too small to read or discern. Generally, after zooming in to view some portion of the display in detail, the user may then “zoom out” to restore the original scale of the display to view an overall layout of the display and possibly to zoom in to another area of the display. Such zooming may be termed “graphical zoom”, as the relative proportions of the various visual elements that are provided in the display, as well as the visual content provided, are not altered during zooming operations.

### BRIEF DESCRIPTION OF DRAWINGS

The present disclosure is illustrated by way of example and not limitation in the figures of the accompanying drawings, in which like references indicate similar elements and in which:

FIG. 1 is a block diagram of an example system having a client-server architecture for an enterprise application platform capable of employing the systems and methods described herein;

FIG. 2 is a block diagram of example applications and modules employable in the enterprise application platform of FIG. 1;

FIG. 3 is a block diagram of example modules utilized in the enterprise application platform of FIG. 1 for systems and methods of semantic zooming of data object representations in a user interface;

FIG. 4A is a flow diagram of an example method of semantic zooming for a zoom-in operation;

FIG. 4B is a flow diagram of an example method of semantic zooming for a zoom-out operation;

FIG. 5 is a flow diagram of an example method of query/response communications related to a semantic zooming operation;

FIG. 6 depicts several example interface displays resulting from various semantic zooming operations on graphical representations of a single data object;

FIG. 7 depicts several example interface displays resulting from various semantic zooming operations on graphical representations of multiple data objects in a listing;

FIG. 8 depicts several example interface displays resulting from various semantic zooming operations on graphical representations of multiple data objects displayed individually; and

FIG. 9 depicts a block diagram of a machine in the example form of a processing system within which may be executed a set of instructions for causing the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Various example methods and systems described below facilitate semantic zooming in a user interface. In one example, a first graphical representation (for example, an icon) of a data object (for example, a file) is presented for display to a user. The first graphical representation presents first information associated with the first data object. In response to a user input indicating a zoom-in operation, the first graphical representation is replaced with a second graphical representation of the data object for display, wherein the second graphical representation presents more information, such as more detailed information, than the first graphical representation. In some examples, further zoom-in operations present even more information regarding the data object. Each zoom-in operation affecting the graphical representation of the data object may be associated with a different representation data level. Zoom-out operations may also traverse these same representation levels, with each zoom-out operation resulting in less detailed information being provided to the user. As a result, various details regarding the data object may be obtained quickly without opening the file by way of a separate application associated with the data object. Other aspects of the embodiments discussed herein may be ascertained from the following detailed description.

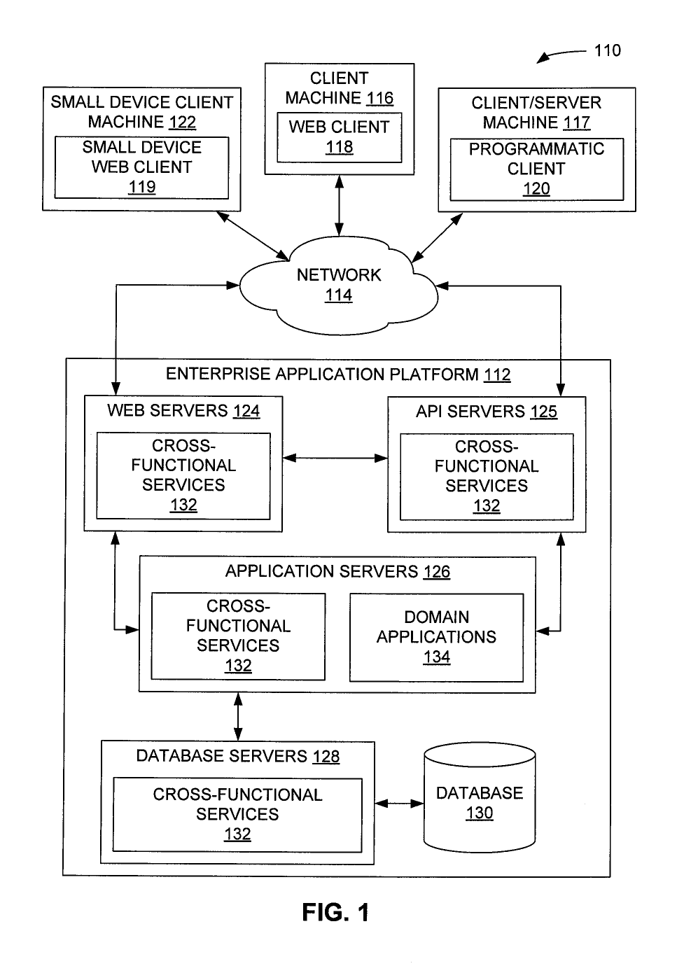

FIG. 1 is a network diagram depicting an example system 110, according to one exemplary embodiment, having a client-server architecture configured to perform the various methods described herein. A platform (e.g., machines and software), in the exemplary form of an enterprise application platform 112, provides server-side functionality via a network 114 (e.g., the Internet) to one or more clients. FIG. 1 illustrates, for example, a client machine 116 with a web client 118 (e.g., a browser, such as the Internet Explorer® browser developed by Microsoft Corporation of Redmond, Washington State), a small device client machine 122 with a small device web client 119 (e.g., a browser without a script engine) and a client/server machine 117 with a programmatic client 120.

Turning specifically to the enterprise application platform 112, web servers 124, and Application Program Interface (API) servers 125 are coupled to, and provide web and programmatic interfaces to, application servers 126. The application servers 126 are, in turn, shown to be coupled to one or more database servers 128 that may facilitate access to one or more databases 130. The web servers 124, Application Program Interface (API) servers 125, application servers 126, and database servers 128 may host cross-functional services 132. The application servers 126 may further host domain applications 134.

The cross-functional services 132 may provide user services and processes that utilize the enterprise application platform 112. For example, the cross-functional services 132 may provide portal services (e.g., web services), database services, and connectivity to the domain applications 134 for users that operate the client machine 116, the client/server machine 117, and the small device client machine 122. In addition, the cross-functional services 132 may provide an environment for delivering enhancements to existing applications and for integrating third party and legacy applications with existing cross-functional services 132 and domain applications 134. Further, while the system 110 shown in FIG. 1 employs a client-server architecture, the present disclosure is of course not limited to such an architecture, and could equally well find application in a distributed or peer-to-peer architecture system.

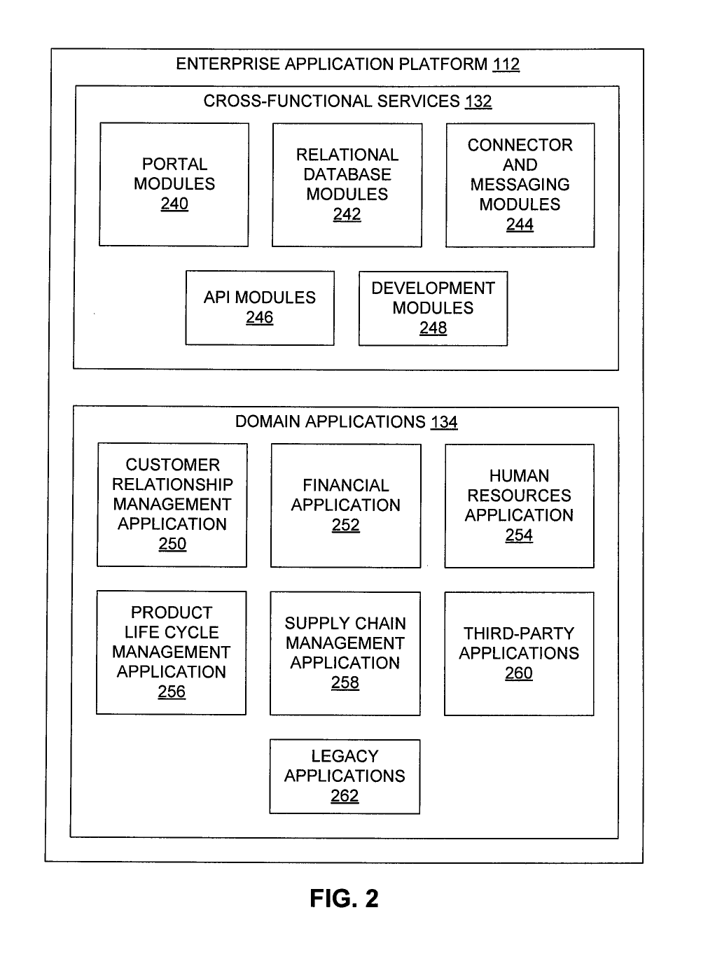

FIG. 2 is a block diagram illustrating example enterprise applications and services, such as those described herein, as embodied in the enterprise application platform 112, according to an exemplary embodiment. The enterprise application platform 112 includes the cross-functional services 132 and the domain applications 134. The cross-functional services 132 include portal modules 240, relational database modules 242, connector and messaging modules 244, Application Program Interface (API) modules 246, and development modules 248.

The portal modules 240 may enable a single point of access to other cross-functional services 132 and domain applications 134 for the client machine 116, the small device client machine 122, and the client/server machine 117 of FIG. 1. The portal modules 240 may be utilized to process, author, and maintain web pages that present content (e.g., user interface elements and navigational controls) to the user. In addition, the portal modules 240 may enable user roles, a construct that associates a role with a specialized environment that is utilized by a user to execute tasks, utilize services, and exchange information with other users and within a defined scope. For example, the role may determine the content that is available to the user and the activities that the user may perform. The portal modules 240 may include, in one implementation, a generation module, a communication module, a receiving module, and a regenerating module. In addition, the portal modules 240 may comply with web services standards and/or utilize a variety of Internet technologies, including, but not limited to, Java, J2EE, SAP's Advanced Business

Application Programming Language (ABAP) and Web Dynpro, XML, JCA, JAAS, X.509, LDAP, WSDL, WSRR, SOAP, UDDI, and Microsoft .NET.

The relational database modules 242 may provide support services for access to the database 130 (FIG. 1) that includes a user interface library. The relational database modules 242 may provide support for object relational mapping, database independence, and distributed computing. The relational database modules 242 may be utilized to add, delete, update, and manage database elements. In addition, the relational database modules 242 may comply with database standards and/or utilize a variety of database technologies including, but not limited to, SQL, SQLDBC, Oracle, MySQL, Unicode, and JDBC.

The connector and messaging modules 244 may enable communication across different types of messaging systems that are utilized by the cross-functional services 132 and the domain applications 134 by providing a common messaging application processing interface. The connector and messaging modules 244 may enable asynchronous communication on the enterprise application platform 112.

The Application Program Interface (API) modules 246 may enable the development of service-based applications by exposing an interface to existing and new applications as services. Repositories may be included in the platform as a central location to find available services when building applications.

The development modules 248 may provide a development environment for the addition, integration, updating, and extension of software components on the enterprise application platform 112 without impacting existing cross-functional services 132 and domain applications 134.

Turning to the domain applications 134, a customer relationship management application 250 may enable access to and facilitate collecting and storing of relevant personalized information from multiple data sources and business processes. Enterprise personnel that are tasked with developing a buyer into a long-term customer may utilize the customer relationship management application 250 to provide assistance to the buyer throughout a customer engagement cycle.

Enterprise personnel may utilize a financial application 252 and business processes to track and control financial transactions within the enterprise application platform 112. The financial application 252 may facilitate the execution of operational, analytical, and collaborative tasks that are associated with financial management. Specifically, the financial application 252 may enable the performance of tasks related to financial accountability, planning, forecasting, and managing the cost of finance.

A human resources application 254 may be utilized by enterprise personal and business processes to manage, deploy, and track enterprise personnel. Specifically, the human resources application 254 may enable the analysis of human resource issues and facilitate human resource decisions based on real-time information.

A product life cycle management application 256 may enable the management of a product throughout the life cycle of the product. For example, the product life cycle management application 256 may enable collaborative engineering, custom product development, project management, asset management, and quality management among business partners.

A supply chain management application 258 may enable monitoring of performances that are observed in supply chains. The supply chain management application 258 may facilitate adherence to production plans and on-time delivery of products and services.

Third-party applications 260, as well as legacy applications 262, may be integrated with the domain applications 134 and utilize the cross-functional services 132 on the enterprise application platform 112.

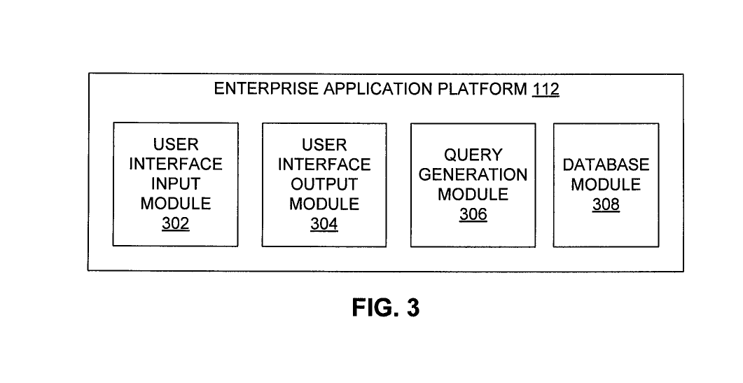

FIG. 3 is a block diagram of example modules employable in the enterprise application platform 112 of FIG. 1 for systems and methods of semantic zooming of data object representations in a user interface, as mentioned above. In the example of FIG. 3, the enterprise application platform 112 includes a user interface input module 302, a user interface output module 304, a query generation module 306, and a database module 308. In some implementations, one or more of these modules may be incorporated in other modules of the enterprise application platform 112. For example, the user interface input module 302 and the user interface output module 304 may exist as two of the portal modules 240 (FIG. 2), while the database module 310 may be one of the relational database modules 242 (also FIG. 2) or another type of database module or storage facility not explicitly shown in FIG. 2. Further, any of the modules 302 through 308 may be combined into fewer modules or may be partitioned into a greater number of modules. In yet other examples, the systems and methods described herein may be employed in modules located partially or completely outside the context of the enterprise application platform 112, such as in a client machine 116, 117, 122, or in a computing or communication device not connected with the system 110 of FIG. 1.

The user interface input module 302 may accept input from a user by way of any user input device, such as a keyboard, mouse, or the like. Some embodiments described hereinafter make particular use of a selection button of a mouse (such as the left-side button) or a scroll wheel of a mouse, but other hardware components of a user input device may be employed in other examples. As discussed below, the input from the user may be utilized to select a graphical representation (or a group of graphical representations) of a display for zooming in or zooming out, to provide user preference information regarding how the graphical representations and associated information are to be displayed, and to facilitate other functionality described below under user control.

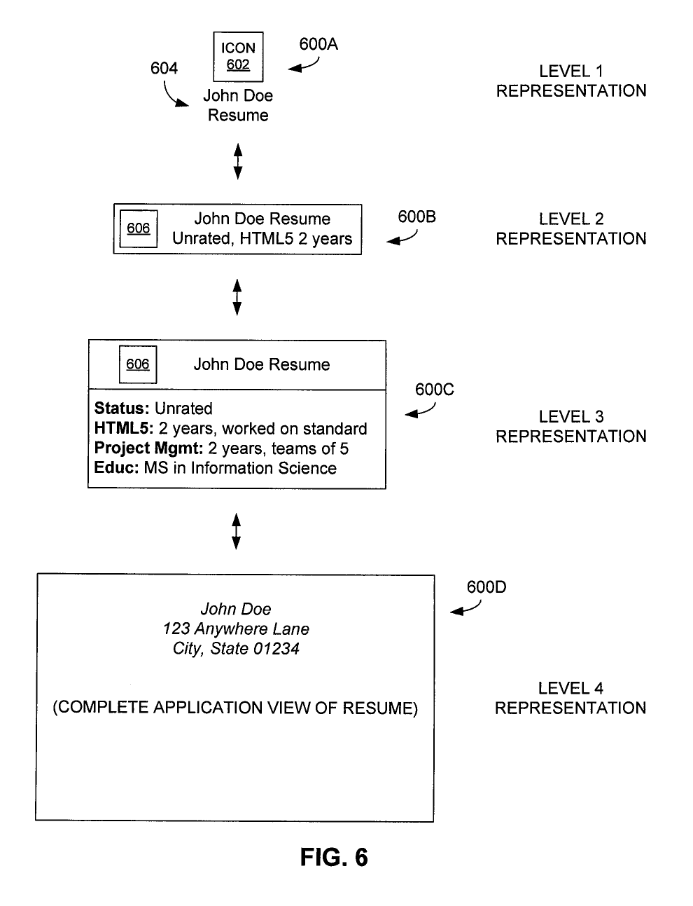

The user interface output module 304 may provide the user with a visual display of one or more graphical representations (such as, for example, icons, rectangles, other convex shapes, and the like), along with information associated with, and displayed within or close to, each of the graphical representations. Examples of such displays are provided in FIGS. 6, 7, and 8, which are described in greater detail below. The user interface output module 304 may present these displays to the user by way of any visual display device, such as a flat panel display for a desktop computer, laptop computer, computer tablet, cellular phone, personal digital assistant (PDA), or other electronic device. The user interface output module 304 may also provide any type of visual interface to allow the user to specify user preferences for the display, to access an item of information indicated in the display, and so on.

The query generation module 306 may generate database queries regarding one or more graphical representations of the display, such as graphical representations specifically selected by the user for a semantic zoom operation, and forward the queries to the database module 308. As described below, the queries may include, in some examples, an indication of a graphical representation selected by the user, an indication of whether a zoom-in or zoom-out operation is to be performed, and/or the current information state or level associated with the selected region. In some implementations, the queries may also specify information related to other graphical representations currently being presented for display to the user. The query generation module 306 may also receive from the database module 308 a response associated with each forwarded query. The response may include, but is not limited to, a new graphical representation, the information to be presented in or with the new graphical representation, and/or the location of the region to be displayed.

The database module 308 may facilitate the storage and retrieval of information regarding the various graphical representations and associated information being presented on a display to the user. Such information may include, for example, the current size and location of each graphical representation, as well as the information to be presented in each region. In some examples, the information stored via the database module 308 may also include size, location, and/or presentation data of the graphical representations for various data objects presuming one or more zoom-in or zoom-out operations are to be applied thereto. One example of the database module 308 is a relational database, but any other type of storage facility capable of performing the various storage and retrieval functions commensurate with the various examples discussed below may also serve as the database module 308. In some cases, the database data may be stored in the memory of a server or other system, as opposed to an externally-located database, thus facilitating faster read and write access to the information associated with the one or more graphical representations being displayed.

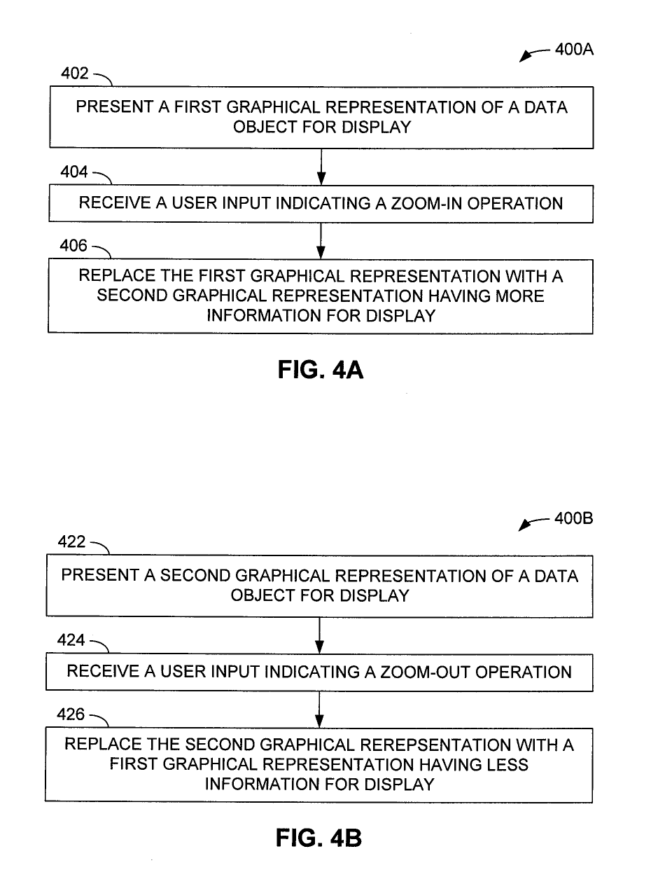

FIG. 4A illustrates an example method 400A of semantic zooming for a zoom-in operation. Generally, a semantic zoom-in operation may result in one or more graphical representations associated with one or more data objects being replaced with other graphical representations to present greater or more detailed information not previously presented in conjunction with the first graphical representations. Thus, a semantic zoom-in operation is distinguished from a purely graphical zoom-in operation, in which information previously displayed is enlarged or magnified graphically to facilitate reading of the information. Conversely, FIG. 4B depicts an example method 400B of semantic zooming for a zoom-out operation, in which one or more graphical representations may be replaced with other graphical representations, accompanied with less, or less detailed, information, presented in connection with the graphical representations. In some examples, any of the operations depicted in FIGS. 4A and 4B may be performed within the enterprise application platform 112 of FIG. 1 (such as by the modules 302 through 308 of FIG. 3), one or more of the client machines 116, 117, or 122 of FIG. 1, or another computing or communication device.

In the method 400A of FIG. 4A, a first graphical representation for a data object is provided or presented for display to a user (operation 402). Examples of the first graphical representation include, but are not limited to, an icon, a rectangle or other geometric shape, a “quick view” window, a thumbnail view, and a full application window. Each of the graphical representations relates some level of information to the user graphically and/or textually, such as, for example, an icon or other image, a title of the data object, one or more items of header information associated with the data object, and all information provided in the associated data object.

Continuing with the method 400A, a user input indicating a zoom-in operation is received (operation 404). In one example, the user input may include a direct selection of the first graphical representation in the display, such as by way of activating a left-side selection button of a mouse. In another instance, the user may select the first graphical representation via activation of a mouse scroll wheel. In other examples, the user input may select an area of the display near or associated with the first graphical representation. The user may employ other means to indicate the selection of a region in other embodiments.

In response to the user selection (operation 404), the first graphical representation of the data object is replaced with a second graphical representation having more information than the first graphical presentation (operation 406). In some examples, the second graphical representation may be located in a different area of the display than the first graphical representation. Also, the greater amount of information may be presented within a graphical element of the second graphical representation, or located near a graphical element of the second graphical representation on the display. In one example, the information associated with the second graphical representation is associated with a level of detail one level greater than that of the first graphical representation. In one example, the second graphical representation may include buttons, fillable fields, or other forms of input mechanisms that the user may activate to modify or display at least portions of the associated data object. Examples of the types of information that may be associated with a particular representation level are discussed in conjunction with FIGS. 6, 7, and 8.

While the operations of the method 400 of FIG. 4A and other figures provided herein are shown in a specific order, other orders of operation, possibly including concurrent execution of at least portions of one or more operations, may be undertaken in some implementations.

Proceeding to FIG. 4B, an example method 400B for a semantic zoom-out operation begins with the provision or presentation of the second graphical representation of the data object for display to the user (operation 422). A user input indicating the zoom-out operation is received (operation 424). In response to the user input, the second graphical representation may be replaced with the first graphical representation that includes or is associated with less information, or less detailed information, describing the data object than the first graphical representation (operation 426).

With the methods 400A and 400B, the visual details of the graphical representation, as well as the amount and type of information associated therewith, may be determined according to specified levels, as described above. Further, the levels may be predetermined, such as via the database module 308 (FIG. 3) or by user preferences.

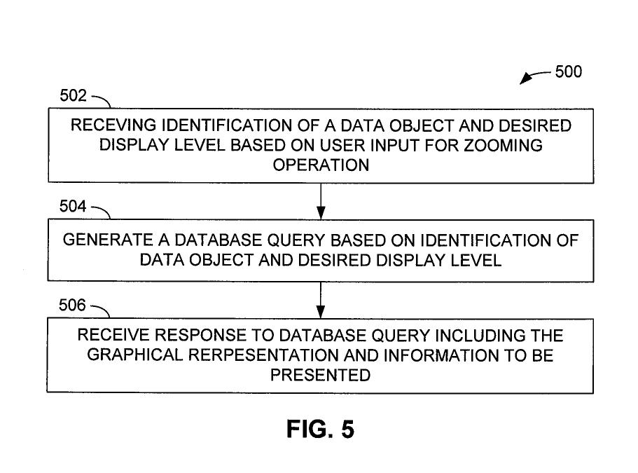

FIG. 5 is a flow diagram of an example method 500 of query/response communications related to a semantic zooming operation. In some implementations, any of the operations of the method 500 may be performed within the enterprise application platform 112 of FIG. 1 (such as by the modules 302 through 308 of FIG. 3), one or more of the client machines 116, 117, or 122 of FIG. 1, or another computing or communication device. In the method 500, an identification of a data object and a desired level of information to be displayed for a graphical representation of the data object are received (operation 502). In an example, the identification of the data object and the desired information level are based upon a user request for a zooming operation, such as a zoom-in or zoom-out operation. In an alternative example, an indication of the zoom operation (for example, zoom-in or zoom-out) and an indication of the current data representation level of the graphical representation may be received instead of the desired information level in conjunction with the identifier of the graphical data object. Based on this information, the query generation module 306 (FIG. 3) may generate a database query based on this information (operation 504) and forward the query to the database module 308.

In reply, the query generation module 306 may receive a response to the query (operation 506) from the database module 308. The response, in one example, may include response data describing the graphical representation to be displayed, including the information to be presented with or as part of the representation. In one example, the data may also indicate the relative location of the graphical representation within the display.

While FIGS. 4A, 4B, and 5 involve zoom-in and zoom-out operations targeting a specific graphical representation, other uses of the zoom-in and zoom-out operations as they apply to multiple graphical representations simultaneously, are described below with respect to FIGS. 6, 7, and 8. Each of FIGS. 6, 7, and 8 illustrate multiple graphical representation levels between which a user may transition based on the use of zooming operations. In these figures, lower-level graphical representations are shown above higher-level graphical representations to indicate that the higher-level representations are associated with greater levels of detailed information compared to their lower-level counterparts. In one implementation, the following examples may be employed within a “collaboration cloud” environment, in which a number of users may contribute to the content of the various data objects associated with the graphical representations described below. However, other environments, such as a single-user desktop environment, may employ the various aspects of the example embodiments described herein.

FIG. 6 illustrates an example set of graphical representations associated with a single data object—in this particular example, a document file of a resume of a prospective employee. To indicate a zoom-in or zoom-out command or operation for the resume, the user may use a mouse or similar graphical input device to position a cursor over the graphical representation of interest, and employ a scroll wheel of the device to semantically zoom in (by rotating the wheel one position toward the user) or zoom out (by rotating the wheel one position away from the user). In another example, the user may use the left-hand selection button of the device to zoom in and the right-hand button of the device to zoom out. However, any other means of indicating and distinguishing between zoom-in and zoom-out operations may be employed in other implementations. In yet other examples, the user need only place the cursor in a vicinity of the graphical representation before activating the zoom-in or zoom-out operation to affect the graphical representation.

Continuing with FIG. 6, a graphical representation 600A associated with a first representation level of the resume is an icon 602 and a title 604 (“John Doe Resume”). In one example, the icon 602 may indicate the particular application with which the data object (the resume) is associated, such as a document viewing or editing application.

During a zoom-in operation, the first graphical representation 600A may be replaced by a second graphical representation 600B associated with a second representation level that provides more detailed information. In this example, the second graphical representation 600B includes a smaller icon 606 that may be a lower-resolution version of the icon 602 of the first graphical representation 600A. The second graphical representation 600B also includes textual information—namely the title of the data object (“John Doe Resume”) and header information (“Unrated, HTML5 2 years”) of the data object, thus providing information not viewable in the first graphical representation. As a result, the overall display area occupied by the second graphical representation 600B is greater than that consumed by the first graphical representation 600A. By virtue of the second graphical representation 600B, the user can determine several important aspects of the resume without having to open the document with its associated application.

In response to another zoom-in operation involving the second graphical representation 600B, the second graphical representation 600B may be replaced by a third graphical representation 600C corresponding to a third representation level that provides the same icon 606, the title or name of the data object, and more detailed header information. More specifically, the header information may include header topics and associated header data, such as a status of the resume of the applicant (“Unrated”, meaning the resume has not been evaluated by the hiring entity), the applicant's experience associated with HTML5 (HyperText Markup Language, Version 5) (“2 years, worked on standard”), the applicant's project management experience (“2 years, teams of 5”), and pertinent education (“MS in Information Science”). Thus, the user may view significant details regarding the resume without actually opening the resume for complete viewing. To provide this information, the third graphical representation 600C occupies more display area than the second graphical information 600B.

Finally, as a result of another zoom-in operation, the third graphical representation 600C may be replaced in the display by a more-detailed fourth graphical representation 600D, which, in this case, is a complete view of the resume. In one example, the fourth graphical representation 600D is produced by opening the associated data object (the resume file) using the application associated with the file, such as a document viewing or editing program. Given the extensive amount of information being provided by the fourth graphical representation 600D, the area occupied by the fourth graphical representation 600D is greater than its counterpart third graphical representation 600C. In another example, the fourth graphical representation 600D may occupy the entire display area available.

The use of zoom-out operations may allow the user to proceed to any of the earlier graphical representations 600A through 600C to reduce the amount of information displayed for the resume. By employing a click wheel or other input selection means, the user may quickly transition between adjacent representation levels quickly. Further, other user input may be employed to skip one or more representation levels, such as by double-clicking the first graphical representation 600A or the second graphical representation 600B to open the resume, resulting in the display of the fourth graphical representation 600D. Similarly, a single input means may cause a transition from the fourth graphical representation 600D directly to the first graphical representation 600A.

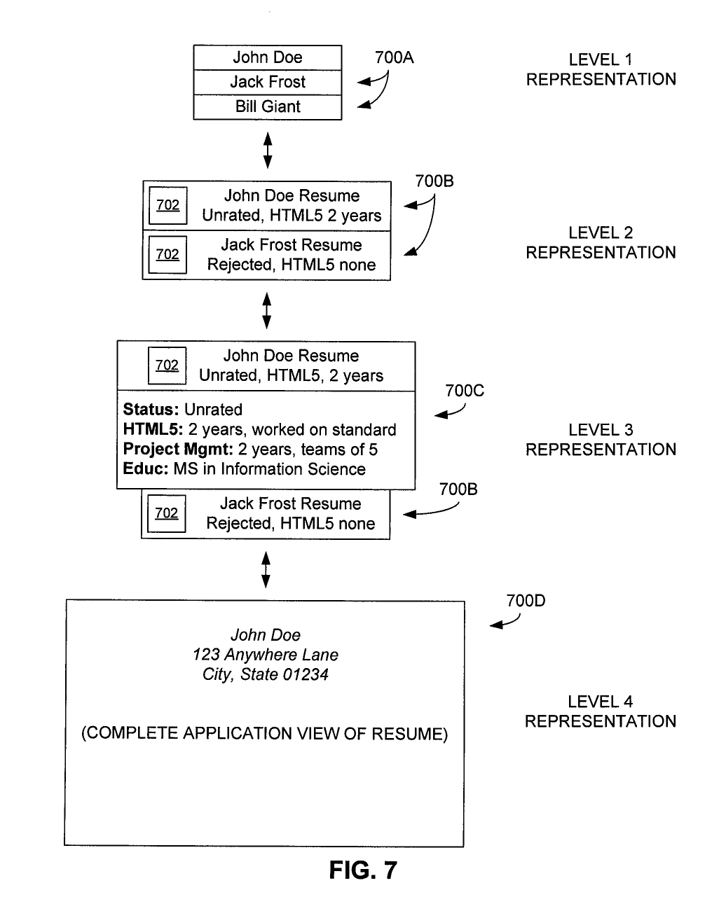

FIG. 7 depicts several example interface displays resulting from various semantic zooming operations on graphical representations 700A through 700D of multiple data objects in a listing. In one example, a user may initiate a zoom-in operation by activating a selection button or scroll wheel of a mouse or similar device on or near one or more of multiple graphical representations of interest. Also, the user may indicate an area of a display to be affected by the zooming operation by way of placement of the cursor at or near one or more of the graphical representations 700A through 700D. In some implementations, as can be seen in FIG. 7, as the graphical representations 700A through 700D become more detailed due to one or more zoom-in operations, the display area consumed by each representation may increase, thus possibly causing the number of graphical representations presented at any one time to be reduced. Similarly, multiple zoom-out operations may result in progressively more graphical representations to be displayed.

Continuing with FIG. 7, a set of first graphical representations 700A are displayed as a list, with each first graphical representation 700A being a rectangular area with a person's name presented therein (John Doe, Jack Frost, and Bill Giant). In this instance, the list of first graphical representations 700A is a list of job applicants, each of which has submitted a resume for consideration.

In response to a zoom-in operation, the three first graphical representations 700A are replaced on the display with two second graphical representations 700B representing the resumes of the first two employees from the list of first graphical representations 700A. In one example, the first two first graphical representations 700A are selected for the zoom-in operation based on a location of the cursor at the time of the operation, such as over one of the first two of the first graphical representations 700A, or nearer the first two of the first graphical representations 700A than the third of the first graphical representations 700A. The two second graphical representations 700B each includes an icon 702 possibly indicating the type of data object, such as a document file. Each of the second graphical representations 700B also includes a title, name, or description of the data object (“John Doe Resume”, “Jack Frost Resume”), and some header information from the data object (“Unrated, HTML5 2 years”, “Rejected, HTML5 none”) indicating a review status of the application and an experience level regarding a particular skill. As the two second graphical representations 700B provide more detailed information than their counterpart first graphical representations 700A, thus occupying more display area, the data object associated with the third first graphical representation 700A is not displayed at the second representational level.

After another zoom-in operation targeting the second graphical representation of the first resume (“John Doe Resume”), the second graphical representation 700B for that resume is replaced with a third graphical representation 700C, while the second graphical representation 700B for the second resume (“Jack Frost Resume”) remains in the display. Such a display may result from the user specifically selecting the second graphical representation 700B of the John Doe Resume prior to, or in conjunction with, the zoom-in operation, such as by way of allowing the cursor to hover over the second graphical representation 700B of the John Doe resume. As a result, less than all of the second graphical representations 700B may be subject to a zoom-in operation, such as by way of the user specifically indicating that a specific second graphical representation 700B is the subject of the zoom-in operation. In some embodiments, such targeted zoom-in operations may be applied at any graphical representation level. In other examples, the third graphical representation 700C for both the first and second resumes may be displayed. This particular display may occur if the user selects some area close to either or both of the resumes represented, but does not specifically target a particular second graphical representation 700B.

Similar to the third graphical representation 600C of FIG. 6, the third graphical representation 700C for the first resume includes header information indicating a status of the resume of the applicant (“Unrated”), the applicant's experience associated with HTML5 (“2 years, worked on standard”), the applicant's project management experience (“2 years, teams of 5”), and pertinent education (“MS in Information Science”). Thus, the user may quickly peruse significant details regarding a resume of interest.

If the third graphical representation 700C for the John Doe resume is the target of another zoom-in operation, a fourth graphical representation 700D providing the complete text of the resume is presented in the display. This graphical representation 700D may result from the resume being opened in an application associated with the resume, such as a document reader or editor application. Further, the fourth graphical representation 700D may occupy a significant portion of the display area, such as the entire display area. As a result, the second graphical representation 700B of the Jack Frost resume is removed from the display. As with FIG. 6, one or more zoom-out operations will cause the presentation of the less-detailed graphical representations to replace the more-detailed representations.

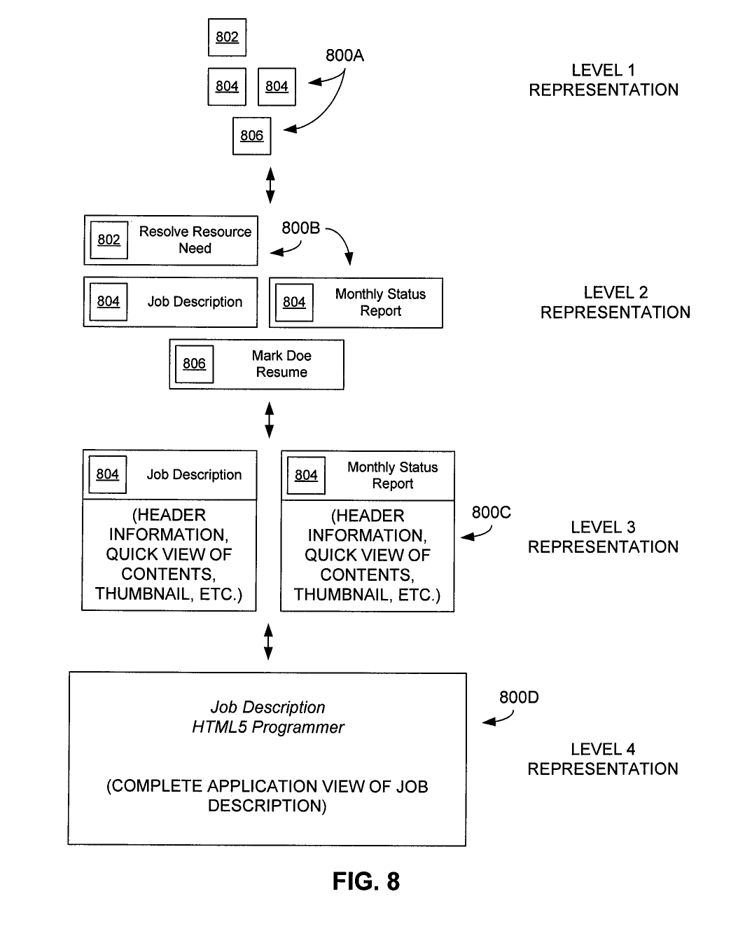

FIG. 8 depicts several example interface displays resulting from various semantic zooming operations on graphical representations 800A through 800D of multiple data objects displayed individually. In this specific example, the first graphical representations 800A are four icons associated with a first presentation level, with each icon representing a separate data object. The icons include a first icon 802 for a first data object type, two second icons 804 for a second data object type, and a third icon 806 for a third data object type. In one example, the icons 802, 804, 806 are displayed in a virtual desktop environment.

In response to a zoom-in operation, the first graphical representations 800A are replaced with second graphical representations 800B associated with a second presentation level. Each second graphical representation 800B includes the icon of its corresponding first graphical representation 800A, along with a name or title of the corresponding data object. For example, the first icon 802 is associated with a task-oriented data object titled “Resolve Resource Need”, one of the second icons 804 is associated with an editable document data object titled “Job Description”, the other second icon 804 is associated with another editable document data object titled “Monthly Status Report”, and the third icon 806 is associated with a displayable document data object titled “Mark Doe Resume”. Although each of the second graphical representations 800B occupies more display area than its corresponding first graphical representation 800A, enough display area exists to allow each of the second graphical representations 800B to be displayed. Also in this particular example, the second graphical representations 800B maintain the same location in the display area relative to the other second graphical representations 800B.

In response to another zoom-in operation, third graphical representations 800C corresponding to the two editable document data objects (“Job Description” and “Monthly Status Report”) replace their corresponding second graphical representations 800B. Each of the third graphical representations 800C is a “quick view” of at least some contents of its associated data object. In other examples, the type of information provided in the third graphical representation 800C depends on the type of data object involved. For example, quick views may be provided for document objects, thumbnail views may be provided for photo and video data objects, and more complete header information might be provided for other types of objects.

In one example, the user may determine which data objects are to be represented by third graphical representations 800C according to a cursor location at the time of the zoom-in operation. In this example of FIG. 8, locating the cursor over or near one or both of the second graphical representations 800B for the editable document data objects may result in the third graphical representations 800C of the Job Description and Monthly Status Report data objects being displayed. Given the increased display area occupied by the third graphical representations 800C over the second graphical representations 800B previously displayed, second graphical representations 800B associated with the Resolve Resource Need and Mark Doe Resume data objects are no longer displayed.

In response to another zoom-in operation, a fourth graphical representation 800D representing the Job Description data object is displayed. In this example, the entire viewable contents of the Job Description are presented in the fourth graphical representation 800D. These contents may be presented by way of opening the Job Description data object with its associated application, such as a viewable document application, in one example. In another instance, the Job Description may be selected for presentation at this level of detail by way of the user placing the cursor atop the third graphical representation 800C of the Job Description, or at least nearer the third graphical representation 800C of the Job Description than the third graphical representation 800C for the Monthly Status Report. Accordingly, given the increased display area consumed by the fourth graphical representation 800D of the Job Description, no fourth graphical representation for the Monthly Status Report is provided. In one example, the fourth graphical representation 800D of the Job Description may be maximized to consume the entire displayable area.

In one or more of the examples described above, the user may quickly transition from one of the graphical representation levels of a data object to complete access to the data object via another user input. For example, while the user is perusing the second graphical representation 800B for the Job Description data object, the user may issue an input to open the Job Description data object using a single click of a mouse button, thus skipping the third representation level.

In some examples, one or more of the graphical representations of a data object may include one or more input mechanisms, such as input buttons or fields, that a user may activate in order to modify the contents of the data object, modify the graphical representation of the data object, or provide some other functionality associated with the data object.

In at least some embodiments discussed herein, the semantic zooming functionality facilitates enhanced user navigation of data objects presented via a graphical user interface. For example, a user may quickly delve into more detailed information regarding a particular data object without opening the data object with an application, and without relinquishing visibility to all other data objects being presented. Accordingly, access to information regarding multiple data objects may be provided within a relatively small display area. Such functionality may be advantageous in environments in which display area is limited, such as in mobile communication devices, especially when compared to desktop computers, laptop computers, computer tablets, and the like. However, any type of electronic display area employed to provide differing levels of information in a variety of areas may benefit from application of the various principles disclosed herein.

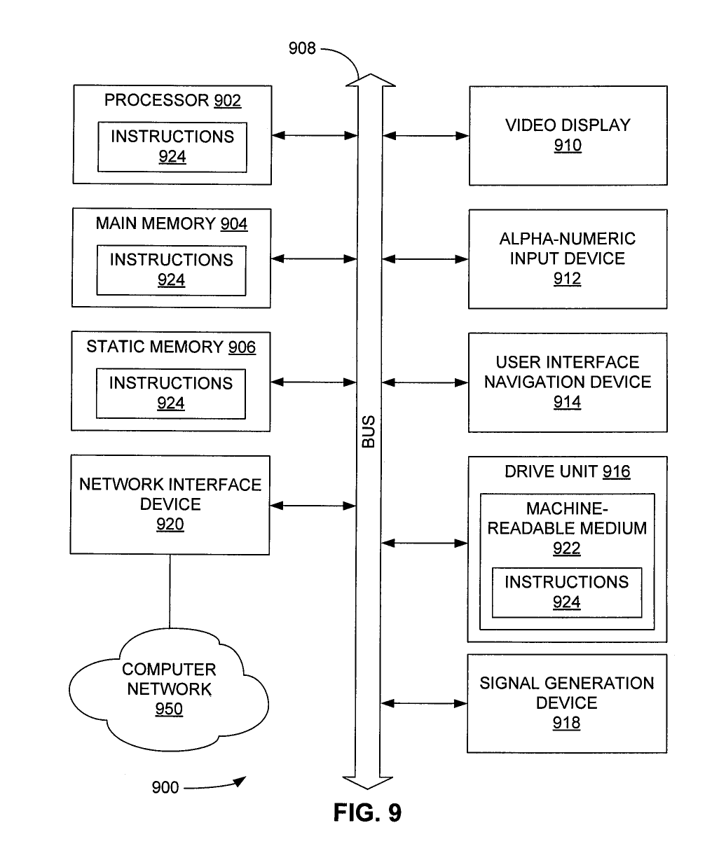

FIG. 9 depicts a block diagram of a machine in the example form of a processing system 900 within which may be executed a set of instructions for causing the machine to perform any one or more of the methodologies discussed herein. In alternative embodiments, the machine operates as a standalone device or may be connected (for example, networked) to other machines. In a networked deployment, the machine may operate in the capacity of a server or a client machine in a server-client network environment, or as a peer machine in a peer-to-peer (or distributed) network environment.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the processing system 900 includes a processor 902 (for example, a central processing unit (CPU), a graphics processing unit (GPU), or both), a main memory 904 (for example, random access memory), and static memory 906 (for example, static random-access memory), which communicate with each other via bus 908. The processing system 900 may further include video display unit 910 (for example, a plasma display, a liquid crystal display (LCD), or a cathode ray tube (CRT)). The processing system 900 also includes an alphanumeric input device 912 (for example, a keyboard), a user interface (UI) navigation device 914 (for example, a mouse), a disk drive unit 916, a signal generation device 918 (for example, a speaker), and a network interface device 920.

The disk drive unit 916 (a type of non-volatile memory storage) includes a machine-readable medium 922 on which is stored one or more sets of data structures and instructions 924 (for example, software) embodying or utilized by any one or more of the methodologies or functions described herein. The data structures and instructions 924 may also reside, completely or at least partially, within the main memory 904, the static memory 906, and/or within the processor 902 during execution thereof by processing system 900, with the main memory 904 and processor 902 also constituting machine-readable, tangible media.

The data structures and instructions 924 may further be transmitted or received over a computer network 950 via network interface device 920 utilizing any one of a number of well-known transfer protocols (for example, HyperText Transfer Protocol (HTTP)).

Certain embodiments are described herein as including logic or a number of components, modules, or mechanisms. Modules may constitute either software modules (for example, code embodied on a machine-readable medium or in a transmission signal) or hardware modules. A hardware module is a tangible unit capable of performing certain operations and may be configured or arranged in a certain manner. In example embodiments, one or more computer systems (for example, the processing system 900) or one or more hardware modules of a computer system (for example, a processor 902 or a group of processors) may be configured by software (for example, an application or application portion) as a hardware module that operates to perform certain operations as described herein.

In various embodiments, a hardware module may be implemented mechanically or electronically. For example, a hardware module may include dedicated circuitry or logic that is permanently configured (for example, as a special-purpose processor, such as a field-programmable gate array (FPGA) or an application-specific integrated circuit (ASIC)) to perform certain operations. A hardware module may also include programmable logic or circuitry (for example, as encompassed within a general-purpose processor 902 or other programmable processor) that is temporarily configured by software to perform certain operations. It will be appreciated that the decision to implement a hardware module mechanically, in dedicated and permanently configured circuitry, or in temporarily configured circuitry (for example, configured by software) may be driven by cost and time considerations.

Accordingly, the term “hardware module” should be understood to encompass a tangible entity, be that an entity that is physically constructed, permanently configured (for example, hardwired) or temporarily configured (for example, programmed) to operate in a certain manner and/or to perform certain operations described herein. Considering embodiments in which hardware modules are temporarily configured (for example, programmed), each of the hardware modules need not be configured or instantiated at any one instance in time. For example, where the hardware modules include a general-purpose processor 902 that is configured using software, the general-purpose processor 902 may be configured as respective different hardware modules at different times. Software may accordingly configure a processor 902, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmissions (such as, for example, over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (for example, a collection of information).

The various operations of example methods described herein may be performed, at least partially, by one or more processors 902 that are temporarily configured (for example, by software) or permanently configured to perform the relevant operations. Whether temporarily or permanently configured, such processors 902 may constitute processor-implemented modules that operate to perform one or more operations or functions. The modules referred to herein may, in some example embodiments, include processor-implemented modules.

Similarly, the methods described herein may be at least partially processor-implemented. For example, at least some of the operations of a method may be performed by one or more processors 902 or processor-implemented modules. The performance of certain of the operations may be distributed among the one or more processors 902, not only residing within a single machine but deployed across a number of machines. In some example embodiments, the processors 902 may be located in a single location (for example, within a home environment, within an office environment, or as a server farm), while in other embodiments, the processors 902 may be distributed across a number of locations.

While the embodiments are described with reference to various implementations and exploitations, it will be understood that these embodiments are illustrative and that the scope of claims provided below is not limited to the embodiments described herein. In general, the techniques described herein may be implemented with facilities consistent with any hardware system or hardware systems defined herein. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims. In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the claims and their equivalents.

What is claimed is:

1. A method, comprising:
presenting a first graphical representation for display, the first graphical representation representing a first data object, the first graphical representation presenting first information associated with the first data object;
receiving a first user input indicating a zoom-in operation; and
in response to the first user input, using at least one processor of a machine, replacing the first graphical representation with a second graphical
representation representing the first data object for display, the second graphical representation presenting second information, the second information including more information than the first information.

2. The method of claim 1, the first user input comprising a selection of the first graphical representation.

3. The method of claim 1, further comprising:
receiving, subsequent to the first user input, a second user input indicating a zoom-in operation; and
in response to the second user input,
replacing the second graphical representation with a third graphical representation for display, the third graphical representation presenting third information, the third information including more information than the second information.

4. The method of claim 1, the first information comprising a first icon, the second information comprising a second icon, the second icon being larger than the first icon and more detailed in appearance than the first icon.

5. The method of claim 4, the second information comprising a title of the first data object.

6. The method of claim 1, the first information comprising an icon, the second information comprising header information of the first data object.

7. The method of claim 6, the header information comprising at least one subject heading of the first data object, and data of the first data object associated with the at least one subject heading.

8. The method of claim 1, the first information comprising header information of the first data object, the second information comprising complete user-accessible information of the first data object.

9. The method of claim 8, further comprising:
in response to the first user input, invoking an application to retrieve the complete user-accessible information of the first data object.

10. The method of claim 8, the replacing of the first graphical representation with the second graphical representation comprising covering an entirety of a displayable area with the second graphical representation.

11. The method of claim 1, comprising:
presenting a plurality of current graphical representations for simultaneous display, each of the plurality of current graphical representations representing a corresponding data object, each of the plurality of current graphical representations presenting current information associated with the corresponding data object, the plurality of current graphical representations comprising the first graphical representation; and
in response to the first user input,
replacing each of a subset of the plurality of current graphical representations with a subsequent graphical representation for display, each of the subsequent graphical representations presenting subsequent information, the subsequent information including more information than the current information of the associated current graphical representation, the subset including the first graphical representation.

12. The method of claim 11, the first user input comprising an indication of a display location; and
the method further comprising selecting, in response to the first user input, the subset of the plurality of current graphical representations based on the indication of the display location.

13. The method of claim 12, the selecting of the subset of the plurality of current graphical representations being further based on at least one of a total display area, a display area occupied by each of the current graphical representations, and a display location of each of the current graphical representations.

14. The method of claim 1, further comprising:
receiving, subsequent to the first user input, a second user input indicating a zoom-out operation; and
in response to the second user input, replacing the second graphical representation with the first graphical representation for display.

15. A non-transitory computer-readable storage medium comprising instructions that, when executed by at least one processor of a machine, cause the machine to perform operations comprising:
presenting a first graphical representation for display, the first graphical representation representing a first data object, the first graphical representation presenting first information associated with the first data object;
receiving a first user input indicating a zoom-in operation; and
in response to the first user input,
replacing the first graphical representation with a second graphical representation representing the first data object for display, the second graphical representation presenting second information, the second information including more information than the first information.

16. The non-transitory computer-readable storage medium of claim 15, the operations further comprising:
receiving, subsequent to the first user input, a second user input indicating a zoom-in operation; and
in response to the second user input,
replacing the second graphical representation with a third graphical representation for display, the third graphical representation presenting third information, the third information including more information than the second information.

17. The non-transitory computer-readable storage medium of claim 15, the operations further comprising:
receiving, subsequent to the first user input, a second user input indicating a zoom-out operation; and
in response to the second user input, replacing the second graphical representation with the first graphical representation for display.

18. A system comprising:
at least one processor of a machine; and
modules comprising instructions that are executable by the at least one processor, the modules comprising:
a user interface output module to present a first graphical representation for display, the first graphical representation representing a first data object, the first graphical representation presenting first information associated with the first data object; and
a user interface input module to receive a user input indicating a zoom-in operation and, in response to the user input, to replace the first graphical representation with a second graphical representation representing the first data object for display, the second graphical representation presenting second information, the second information including more information than the first information.

19. The system of claim 18, further comprising:
a query generation module to generate a query comprising an identification of the first data object and a desired display level based on the user input; and
a database module to generate a response for the query, the response comprising the second information.

20. The system of claim 18, the user input being initiated by one of an activation of a mouse selection button and an activation of a mouse scroll wheel.
